(19) United States
(12) Patent Application Publication
(10) Pub. No.: US 2002/0046864 A1
(43) Pub. Date: Apr. 25, 2002

(54) Method of joining conductive materials

(76) Inventors: Joseph P. Bellino, Simsbury, CT (US); Michael J. Caulfield, Essex, CT (US); Steven E. Richard, Selmer, TN (US); David Arnold, Chester, CT (US)

Correspondence Address: CANTOR COLBURN, LLP, 55 GRIFFIN ROAD SOUTH, BLOOMFIELD, CT, 06002

(21) Appl. No.: 09/682,206

(22) Filed: Aug. 6, 2001

Related U.S. Application Data
(63) Continuation of application No. 09/561,858, filed on Apr. 28, 2000, now abandoned.

(51) Int. Cl. H02G 3/00

(52) U.S. Cl. 174/70 B

(57) ABSTRACT

A method is described for joining electrically conducting members using an apparatus having a pin typically formed of a material harder than the electrically conducting members. The apparatus causes the pin to rotate at high speeds between the electrically conducting members, wherein the rotating pin causes a portion of material from each electrically conducting member to plasticize and solidify a joint. By translating the apparatus along the joint, the pair of electrically conducting members can be joined without requiring the inclusion of additional filler material.

### CROSS REFERENCE TO RELATED APPLICATIONS

This application is a continuation-in-part of U.S. patent application Ser. No. 09/561,858, entitled METHOD OF JOINING CONDUCTIVE MATERIALS, which is incorporated herein by reference in its entirety.

### BACKGROUND OF INVENTION

The present method for joining conductive material components, such as bus bars, in electrical busway is by conventional welding methods such as gas-metal arc welding (GMAW). This joining technique causes excess weld metal to form on the bus bars, which may require additional time and expense for the removal thereof.

Additionally, the GMAW method requires the use of a filler wire. However, filler wire typically has a lower conductivity than the bus bar material, thereby creating a joint that is lower in conductivity than the bus bars that are being welded together. This lower conductivity causes the resistivity of the joint to be higher than the original conductive material, which in turn increases the heat dissipated at the joints. Moreover, GMAW does not lend itself to joining dissimilar metals. For example, applying the GMAW method to join dissimilar metals could jeopardize the structural integrity of one of the metals.

Accordingly, there is a need for an improved arrangement and method to create a joint between conductive materials that minimizes or eliminates conductivity discrepancy between the joint and the original conductive material. Additionally, there is a need for an arrangement that will not produce excess weld metal or oxidation, thereby eliminating the need for extra work and, therefore, decreasing the time and expense required to join conductors together.

### SUMMARY OF INVENTION

A method is described for joining first and second electrically conducting members for use in an electrical enclosure. The method uses an apparatus having a pin that is typically formed of a material harder than said first and second electrically conducting members. The apparatus causes the pin to rotate at high speeds.

A pair of electrically conducting members is positioned together, as to form a joint therebetween. The pin (while rotating or prior to being caused to rotate) is positioned on the joint. The rotating pin causes a portion of material from each electrically conducting member to plasticize and solidify the joint.

By translating the apparatus along the joint, the pair of electrically conducting members (work piece) can be joined without requiring the inclusion of additional material or heat. Alternatively, the work piece to be joined may be translated relative to the rotating pin.

### BRIEF DESCRIPTION OF DRAWINGS

FIG. 1 is a front perspective view of an arrangement of bus bars positioned for welding;

FIG. 2 is a front perspective view of the arrangement of FIG. 1 including a friction stir welding apparatus positioned according to an exemplary embodiment;

FIG. 3 is a front perspective view of the arrangement of FIGS. 1 and 2 including the bus bars partially welded together;

FIG. 4 is a front perspective view of the arrangement of FIGS. 1-3 including the bus bars completely welded together;

FIG. 5 is a top plan view of an arrangement of bus bars positioned for friction stir welding according to an alternative exemplary method;

FIG. 6 is a side elevation view of an Al bus bar friction stir welded to a Cu termination lead;

FIG. 7 is a double sided friction stir weld shown in FIG. 6; and

FIG. 8 is a schematic view of an apparatus for producing the double-sided weld shown in FIG. 7.

### DETAILED DESCRIPTION

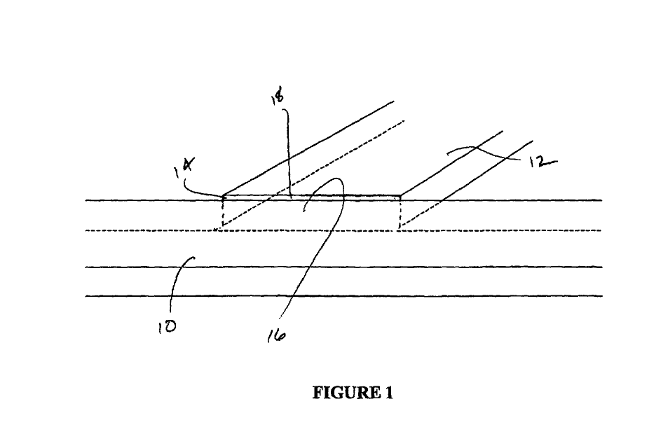

In an exemplary embodiment, conductors 10 and 12 are shown in FIG. 1. Conductors 10 and 12 are positioned together in a T formation, for example, as an arrangement of a bus bar in a bus bar runway (i.e., bus bar 10) and a termination lead (i.e., lead 12) to a power consuming device or power distribution center (not shown). However, in addition to a T-joint between a bus bar and a lead, it is contemplated that the technique described herein may be applied to a butt joint, an L shaped joint, or a mitre joint between a bus bar and a termination lead; a T joint, a butt joint, an L shaped joint, or a mitre joint between a bus bar and a bus bar; or a T joint, a butt joint, an L shaped joint, or a mitre joint between a termination lead and a termination lead. Furthermore, the technique may be employed to repair cracks in conductors, for example, at existing GMAW joints.

An end 14 of lead 12 is positioned so that it is adjacent to an edge portion 16 of bus bar 10 to form a joint 18. Lead 12 is positioned against bus bar 10 to maintain the desired positioning of the between end 14 and edge portion 16. It is contemplated that lead 12 need not be forced tightly against bus bar 10.

Bus bar 10 and lead 12 are formed of similar electrical grade conducting material, such as copper, copper alloys, aluminum, or aluminum alloys. Alternatively, bus bar 10 and lead 12 can be formed of dissimilar conducting materials, such as, for example, where bus bar 10 is aluminum and lead 12 is copper. The dimensions of bus bar 10 and lead 12 can vary. Generally, in an industrial application, for example, a series of bus bars 10 traverse a site, wherein each bus bar corresponds with one phase of power in a multiple phase power system and is constructed of aluminum to reduce weight and cost. Termination leads 12 made of copper or copper alloy (e.g., bronze or brass) are attached to the bus bars to distribute the power to a load. For such applications, bus bars and leads have a thickness typically between 0.0625 in. (1.5875 mm) and 1 in. (25.4 mm), preferably between 0.125 in. (3.175 mm) and 0.75 in. (19.05 mm), and most preferably between 0.1875 in. (4.7625 mm) and 0.3125 in. (7.9375 mm).; a width between 0.5 in. (12.7 mm) and 12 in. (304.8 mm), preferably 1.5 in. (38.1 mm) and 9 in. (228.6 mm), and most preferably between 1.625 in. (41.275 mm) and 8.25 in. (209.55 mm); and an appropriate length depending, for example, on the positioning of loads and power sources.

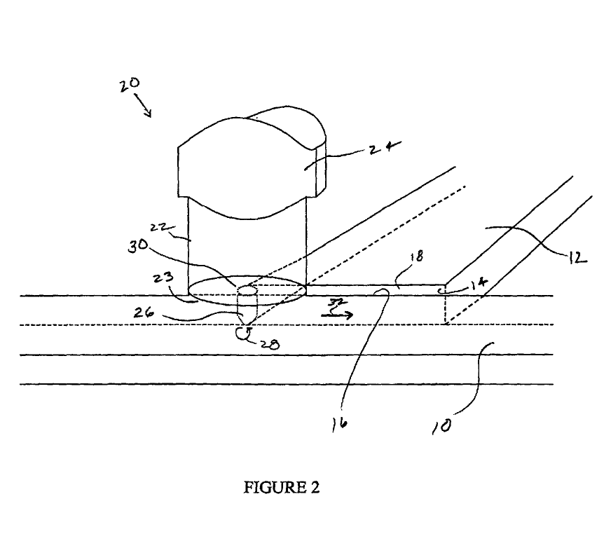

Referring now to FIG. 2, an apparatus 20 is provided for friction stir welding of bus bars 10 and 12. Apparatus 20 includes a cylindrical body 22 having an upper portion 24 being connected to a power source (not shown), for example an electric motor, and a pin 26 attached to cylindrical body 22.

Cylindrical body 22 includes an end 23. End 23 can be of various shapes, including but not limited to flat, cup shaped, or concave. It is contemplated that apparatus 20 can cause pin 26 to rotate using different power sources or configurations. For example, upper portion 24 may be at a right angle to cylindrical body 22. Also, the power source may cause both cylindrical body 22 and pin 26 to rotate. Alternatively, the power source may cause only pin 26 to rotate.

Pin 26 is formed from a material harder than the material forming conductive members 10 and 12. For example, where bus bar 10 and lead 12 are formed of copper or aluminum, pin 26 can be formed of a high carbon content steel, preferably formed from molybdenum.

Pin 26 extends from cylindrical body 22 such that pin 26 is caused to rotate by the power source generally in the counterclockwise direction as indicated by arrow 28. The power source conventionally used by tool machines rotates in a counterclockwise direction, but the teachings of the present invention are not limited to the counterclockwise direction. To facilitate the friction stir welding described herein, pin 26 is rotated at speeds between 500 and 6000 revolutions per minute (RPM), preferably between 1000 and 4000 RPM, and most preferably between 1000 and 1400 RPM. Of course, it is contemplated that the rotational speed of pin 26 may vary depending on factors including, but not limited to, the translational speed of pin 26 across joint 18, the materials of conductors 10 and 12, and other optimization factors. The dimensions of pin 26 depends on the cross sectional dimensions of bus bar 10 and lead 12. For example, in the industrial setting described above, pin 26 can be approximately 0.25 inches thick and sufficiently long to protrude 0.25 to 0.375 inches beyond end 23.

Furthermore, the shape of pin 26 can vary. In FIGS. 2-4, pin 26 is generally depicted as having a blunt pointed, angular tip. However, the body of pin 26 can be various shapes including, but not limited to, cylindrical, conical, frusto conical, and can include a sharp pointed, flat, blunt pointed, or otherwise rounded tip.

Pin 26 is arranged adjacent at a corner 30 formed by the junction of end 14 and edge portion 16 (i.e., adjacent to joint 18) as shown in FIG. 2. While pin 26 is rotating, apparatus 20 is translated generally in the direction indicated by arrow 32 driving pin 26 into and along joint 18. While the speed that apparatus 20 is translated across joint 18 may vary, in the industrial setting described above, speeds are approximately 1 in. (2.54 cm) per min. to 100 in. (254 cm) per min., preferably 3 in. (7.62 cm) per min. to 60 in. (152 cm) per min., more preferably between about 10 to about 14 inches per min., and most preferably 12 in. (30.5 cm) per min. to 50 in. (127 cm) per min. It is contemplated, of course, that pin 26 can be plunged into any point along joint 18 and translated in either direction along joint 18. If it is required that joint 18 be completely sealed, then pin 26 must be translated through the remaining portion of joint 18. Alternatively, the work piece, for example bus bar 10 and lead 12, may be translated relative to a rotating but stationary pin 26.

The rotation and translation speeds that apparatus 20 operates at across joint 18 is dependent on many factors, including but not limited to the thickness of the work piece to be joined and the thermal mass of the work piece to be joined. In the industrial settings above, the translation speeds are described to be in the 1 in. (2.54 cm) per min. to 100 in. (254 cm) per min. range, and the rotation speeds are described to be in the 500 to 6000 RPM range, however, it will be appreciated that slower translation speeds and faster rotation speeds are also contemplated where they do not result in thermal degradation of the work piece, joint or apparatus, collectively referred to as FSW-thermal-threshold. If the FSW-thermal-threshold is exceeded, by operating at too slow of a translation speed or too fast of a rotation speed for example, it is likely that thermal degradation of the work piece, joint or apparatus will result. At the other extreme, it will also be appreciated that as long as the work piece is plasticized during the friction stir welding process, translation speeds in excess of 100 in. (254 cm) per min. and rotation speeds below 500 RPM are also contemplated. Thus, the threshold translation and rotation speeds of apparatus 20 are more properly determined by the ability of apparatus 20 to plasticize the work piece, referred to as FSW-plasticization-threshold. If the FSW-plasticization-threshold is not reached, by operating at too fast of a translation speed or too slow of a rotation speed for example, plasticization of the work piece will not result across joint 18 and a successful friction stir welding joint will not result.

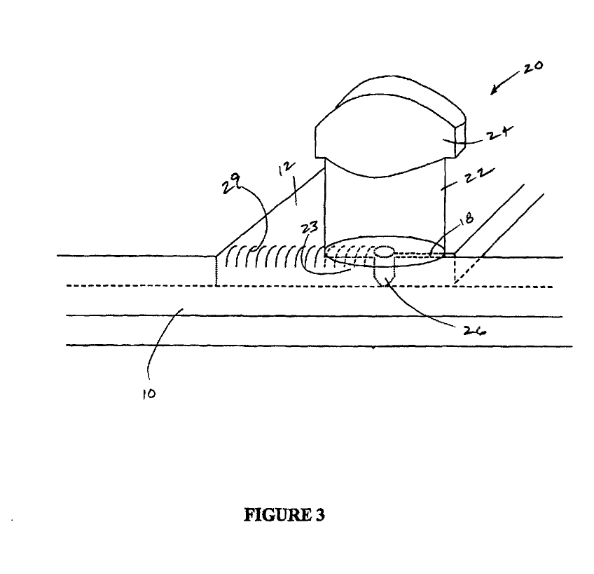

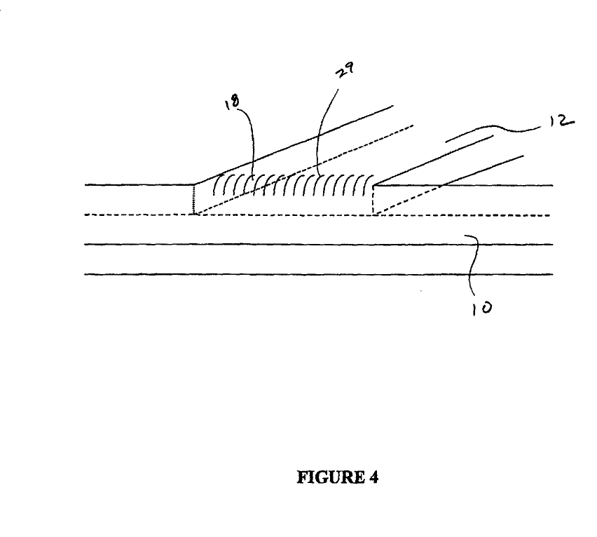

Referring now to FIGS. 3 and 4, as the rotating pin 26 is translated through joint 18, a local region of highly plasticized material is produced around pin 26. The material is from both bus bar 10 and lead 12.

Some of the plasticized material is thrown into end 23 and is forced back into joint 18. If end 23 is cupped or concave, pin 26 can be translated across joint 18 at higher rates of speed than if end 23 were flat. Plasticized material will not cause pin 26 to slow down or seize when a cavity is formed in end 23 allowing a temporary depository for plasticized material while pin 26 rotates and translates pushing the plasticized material back in joint 18. During the FSW process, some of the plasticized material has a tendency to be driven toward end 23 of cylindrical body 22 and then forced back into joint 18 as pin 26 translates across the joint. If end 23 is cupped or concave, as opposed to flat for example, pin 26 can be translated across joint 18 at higher rates of speed. The concave cavity in the end 23 provides a temporary depository for the plasticized material while pin 26 rotates and translates across the joint. In this manner, the plasticized material from the concave cavity is pushed back into joint 18 without slowing down or seizing pin 26. The regions of joint 18 that have been traversed by the rotating pin 26 solidify (as indicated by a plurality of curved lines 29) and conductive members 10 and 12 are attached together. Because no filler is used to attach the conductors, the conductivity between conductors 10 and 12 is minimally affected by joint 18. The conductivity differential due to the weld is generally less than 5%, preferably less than 2%, and most preferably less than 1%.

Furthermore the heat affected zone conventionally found in conventionally welded busway distribution systems is eliminated or minimized. Moreover, when using copper or copper alloy termination leads 12, the copper is not annealed by excessive heat used in conventional welding, thus allowing the copper to retain its structural rigidity. Accordingly, no secondary operation (e.g., machining or cold working), or minimal secondary operation, is required to finish the weld joint created by the methods of the present disclosure.

The strength of joint 18 is at least as strong as, if not stronger, than conventional welds. For example, bus bars of similar material 0.25 inches thick and between 1.625 in. (41.275 mm) and 8.25 in. (209.55 mm) were joined by a friction stir apparatus rotating a pin between 1200 and 1600 RPM and translating 30 in. (76.2 cm) per min. to 50 in. (127 cm) per min. A 180° bend test demonstrated no cracking or breakage at the weld joint.

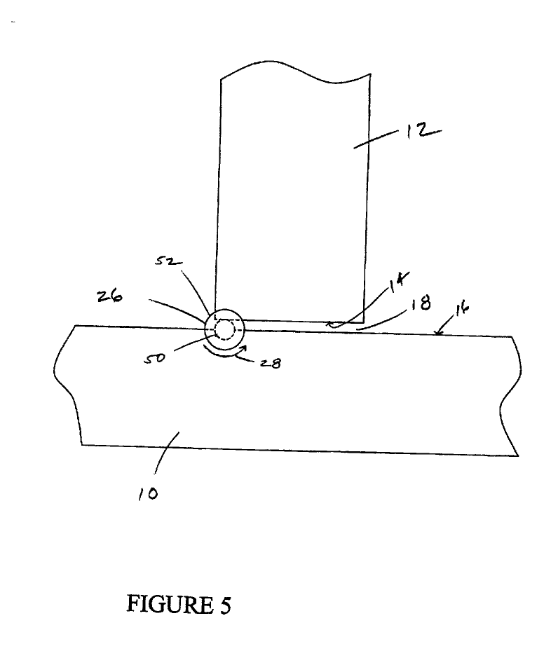

Referring to FIG. 5, a top plan view illustrating an aluminum bus bar 10 and copper termination lead 12 are positioned together in a T formation for friction stir welding. However, in addition to a T-joint between a bus bar and a lead, it is contemplated that the technique described herein may be applied to a butt joint, an L shaped joint, or a mitre joint between a bus bar and a termination lead; a T joint, a butt joint, an L shaped joint, or a mitre joint between a bus bar and a bus bar; or a T joint, a butt joint, an L shaped joint, or a mitre joint between a termination lead 12 and a bus bar 10. An end 14 of lead 12 is positioned so that it is adjacent to an edge portion 16 of bus bar 10 to form a joint 18. Pin 26 is disposed above joint 18 such that it is disposed over a larger portion of aluminum bus bar 10 than a portion of copper termination lead 12. The offset of pin 26 is more clearly illustrated by a tip portion 50 (shown in phantom lines) of pin 26 disposed within joint 18. Tip portion 50 is concentrically disposed within an outside perimeter 52 defining pin 26. An outside perimeter of tip portion 50 is adjacent end 14 of copper lead 12 and is substantially disposed in a large portion of aluminum bus bar 10 to stir a larger portion of the aluminum material side relative to the copper material side on lead 12. This stirring results in a better bond condition at joint 18 than without offsetting pin 26 towards the aluminum material side. Reduced surface and subsurface pores are present in the joint when pin 26 is offset to the Al side, thereby producing a stronger joint and reducing electrical resistance at joint 18.

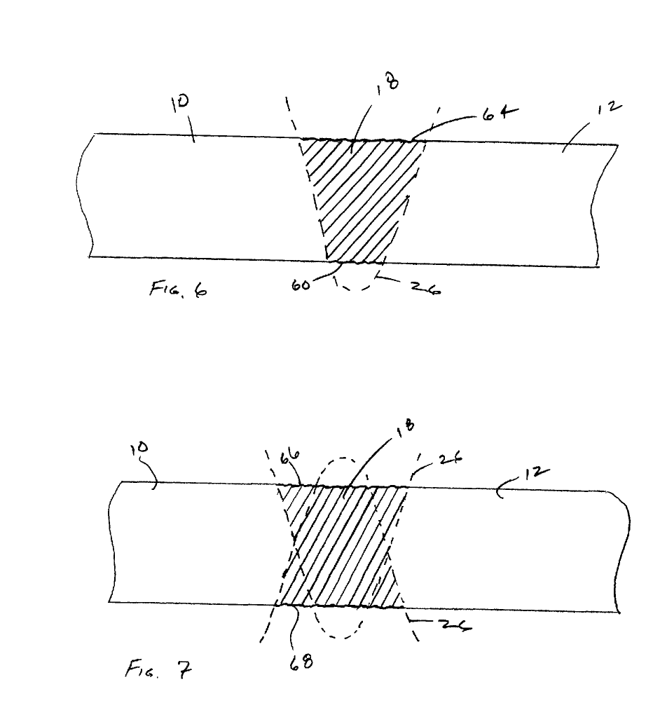

FIG. 6 illustrates a side elevation view of a termination lead joined to a bus bar. A conical tipped pin 26 (a profile of which is shown with phantom lines) produces a finished joint 18 having a root end 60 and a face end 64. In bending tests of joints 18 between a copper (Cu) termination lead 12 friction stir welded to an aluminum (Al) bus bar 10, bending about the root end 60 passed through 90 degrees (i.e., a root bend places face end 64 in compression); however, bending about the face end 64 passed through 20 degrees (i.e., a face bend places face end 64 in tension).

It is contemplated that elimination of a root end 60 weld results in a stronger joint 18. Referring to FIG. 7, a double sided weld for the same Cu termination lead 12 friction stir welded to Al bus bar in FIG. 6 are shown with a first face end 66 and a second face end 68. The two face end welds are produced by optionally friction stir welding one side of the work piece (i.e., Cu termination lead 12 and Al bus bar 10) with a conical tipped pin 26 shown with phantom lines, and then doing the same with the other side. Another method includes using a pin 26 configured to produce joint 18 shown in FIG. 7. For example, it is foreseen that a pin configured as an hour glass figure produces a similar joint 18.

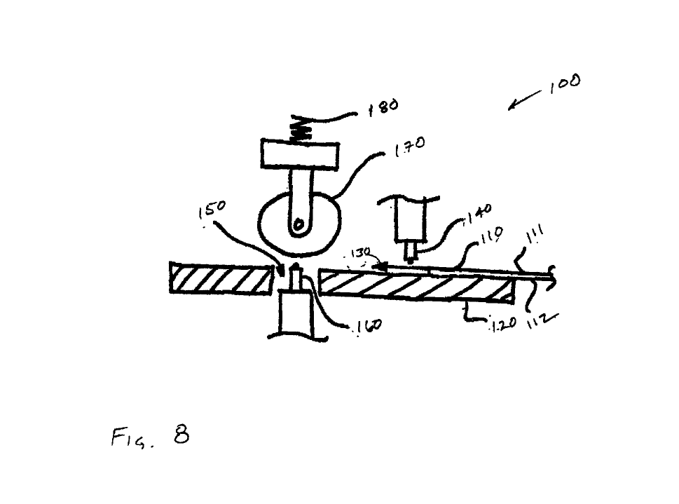

Referring to FIG. 8, a friction stir welding (FSW) apparatus 100 is shown for double sided welding without having to flip a subject work piece. FSW apparatus 100 produces two face end welds 66, 68 producing joint 18 shown in FIG. 7. A work piece 110, comprising two individual parts to be joined together (i.e., a Cu termination lead 12 and an Al bus bar 10 clamped in a position relative to each other, both not shown), is fed along support 20 of FSW apparatus 100 in the direction of arrow 130. FSW apparatus includes a first FSW tool 140 that produces a first FSW face end weld 66 of joint 18 on a first side 111 of work piece 110. Support 120 provides a first physical support to restrain work piece 110 as the first FSW face end weld 66. An opening 150 in support 120 provides access for a second FSW tool 160, which produces a second FSW face end weld 68 on a second side 112 of work piece 110. FSW tools 140, 160 are staggered with respect to each other. A compression roller 170 provides a second physical support to restrain work piece 110 as second FSW toll 160 produces second FSW face end weld 68 of joint 18. Compression roller 170 comprises a compression bias 180 that can be adjusted for effective reaction loading of work piece 110. Other controllable means, such as for example a servo-drive or a stepping motor (not shown), optionally may be used in conjunction or in place of compression bias 180 for a greater degree of control during the manufacturing process. For example, a servo-drive or stepping motor is optionally engaged with compression roller 170 for urging compression roller 170 to rotate and thereby translate work piece 110 relative to support surface 120. It will be appreciated that a FSW joint having a root end and a face end or two face ends can be accomplished by translating the FSW tool across a stationary work piece or by translating the work piece across a stationary FSW tool, as shown and described herein.

The method described herein allows an electrically conductive bus bar having dissimilar metals to be joined, which was previously unattainable with methods of the prior art. For example, the method disclosed herein allows Cu tabs to be attached to an Al bus bar. The Al bus bar is lighter and less expensive compared to a bus bar made from Cu. By contrast, Cu tabs offer better electrical conductivity to the devices they are connected with compared to Al tabs. Thus, a Cu tab friction stir welded to an Al bus bar weighs less and costs less than an all Cu bus bar distribution network and offers efficient electrical conductivity over an all Al bus bar distribution network.

While the invention has been described with reference to a preferred embodiment and various alternative embodiments, it will be understood by those skilled in the art that changes may be made and equivalents may be substituted for elements thereof without departing from the scope of invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of fabricating a bus bar distribution system by joining electrically conducting members, the method comprising:
selecting a first electrically conductive member made from a material selected from the group consisting of copper and copper alloy;
selecting a second electrically conductive member made from a material selected from the group consisting of aluminum and aluminum alloy;
abutting said first electrically conductive member against said second electrically conductive member;
inserting a pin between said first electrically conductive member and said second electrically conductive member;
rotating said pin to cause a portion of material from said first electrically conductive member and said second electrically conductive member to plasticize regions of said first electrically conductive member and said second electrically conductive member;
translating said pin between a portion of said first electrically conductive member and said second electrically conductive member to plasticize said portion; and
cooling said plasticized regions to create a joint between said first electrically conductive member and said second electrically conductive member, said joint having a small conductive differential relative to the conducting members being joined.

2. The method as in claim 1, further comprising rotating and translating said pin at a combined rotational and translational speed between a FSW-thermal-threshold and a FSW-plasticization-threshold.

3. The method as in claim 1, further comprising selecting said pin from a material including carbon steel.

4. The method as in claim 3, further comprising rotating said pin between about 500 and about 6000 revolutions per minute.

5. The method as in claim 3, further comprising rotating said pin between about 1000 and about 4000 revolutions per minute.

6. The method as in claim 3, further comprising rotating said pin between about 1200 and about 1600 revolutions per minute.

7. The method as in claim 1, further comprising rotating said pin with an apparatus including a body having an end, wherein said pin extends from said end.

8. The method as in claim 7, further comprising selecting said end from a shape selected from the group consisting of flat, cup-shaped and concave.

9. The method as in claim 8, further comprising translating said pin speed of between about 1 inch per minute to about 100 inches per minute between a portion of said first electrically conductive member and said second electrically conductive member to plasticize said portion.

10. The method as in claim 8, further comprising translating said pin speed of between about 3 inches per minute to about 60 inches per minute between a portion of said first electrically conductive member and said second electrically conductive member to plasticize said portion.

11. The method as in claim 8, further comprising translating said pin speed of between about 12 inches per minute to about 50 inches per minute between a portion of said first electrically conductive member and said second electrically conductive member to plasticize said portion.

12. The method as in claim 1, further comprising:
offsetting said pin towards said second electrically conductive member for inducing more stirring of a plasticized region within said second electrically conductive member.

13. A busway distribution system comprising:
a bus bar electrically joined with a first friction stir weld to a termination lead, wherein a conductivity differential between said bus bar and said termination lead is less than about 5%.

14. The busway distribution system as in claim 13, wherein said conductivity differential is less than about 3%.

15. The busway distribution system as in claim 13, wherein said conductivity differential is less than about 1%.

16. The busway distribution system as in claim 13, further comprising said bus bar and said termination lead electrically joined with a second friction stir weld, wherein said second friction stir weld opposes said first friction stir weld.

17. An apparatus for joining electrically conducting members with a friction stir weld (FSW), the apparatus comprising:
a support surface for supporting a work piece, said work piece including at least two electrically conducting members to be joined;
a first FSW tool disposed above a first surface of said work piece;
a second FSW tool disposed below a second surface of said work piece through an opening in said support surface;
a physical support aligned with said second FSW tool and disposed above said first surface of said work piece, said physical support is adjustable for biased contact against said first surface of said work piece; and
a means of translating said work piece relative to stationary said first and second FSW tools.

18. The apparatus of claim 17 further comprising a means to translate said physical support and said first and second FSW tools relative to a stationary said work piece.

19. The apparatus of claim 17, wherein said physical support includes a means for varying said bias on said first surface of said work piece.

20. The apparatus of claim 17, wherein said means includes one of a servo-drive and a stepping motor engaged with said physical support, said servo-drive and said stepping motor urging said physical support to translate said work piece relative to said support surface.

21. The apparatus of claim 17, wherein said physical support is at least one of a compression roller, a servo-drive and a stepping motor.
